(19) United States
(12) Patent Application Publication
(10) Pub. No.: US 2012/0139210 A1
(43) Pub. Date: Jun. 7, 2012

(54) Pintle Hitch For Coupling A Towed Implement To A Towing Vehicle

(75) Inventor: James D. Oberg, Eagle Bend, MN (US)

(73) Assignee: TRI GLOBAL ENTERPRISES, INC., Minnetonka, MN (US)

(21) Appl. No.: 12/957,509

(22) Filed: Dec. 1, 2010

(51) Int. Cl. B60D 1/06

(52) U.S. Cl. 280/504

(57) ABSTRACT

A pintle coupler adapted to mate with a hitch ball for connecting a towed implement to a towing vehicle comprises a flat plate member that is bolted or otherwise affixed to a trailer tongue and that has an aperture formed therethrough of a size to fit over the hitch ball. Pivotally joined to the undersurface of the flat plate is a retainer plate having a U-shaped inset whose width is only slightly larger than the diameter of the hitch ball's pedestal. The retainer plate is movable between a first position where the inset is out of alignment with the aperture in the flat plate to a second position where the two are aligned. Further apertures in the flat plate and the retainer plate become aligned when the retainer plate is in its second position, allowing a spring-ball detent pin to be inserted for locking the retainer plate against rotation relative to the flat plate.

### BACKGROUND OF THE INVENTION

I. Field of the Invention

This invention relates generally to hitches for coupling a towed implement to a towing vehicle, and more particularly to a hitch ball coupler for use on garden tractors, riding lawnmowers, ATVs and similar work vehicles for coupling implements, such as trailers, earth tillers, rakes, aerators, leaf vacuums, etc. thereto.

II. Discussion of the Prior Art

Many different trailer hitch designs are known in the art for coupling a trailer or other implement to a towing vehicle. One ubiquitous arrangement comprises a so-called “ball hitch” where a spherical ball of a predetermined diameter has a pedestal and a threaded shank where the shank is adapted to be fitted through an aperture in a steel bracket and held in place by a bolt, lock washer combination. The bracket typically mounts by a clevis connection to a receiver affixed to the rear of the towing vehicle. Adapted to cooperate with the hitch ball is a coupler having a spherical socket for cupping the ball therein and a retainer mechanism that cooperates with the pedestal to latch the ball within the socket to prevent separation during travel. Such hitch arrangements are often found on small utility trailers, boat trailers, and in other applications where tongue weight and towed load constraints do not demand a more sturdy structure, such as a “fifth wheel” or a “gooseneck”.

The conventional coupler described above, while quite reliable when properly used, suffers from a number of drawbacks, including unintended uncoupling when not properly latched. Improper latching can result because the engagement of the latching mechanism with the hitch ball is hidden from view of the user. Also, the conventional prior art ball hitch coupler tends to be somewhat costly.

Accordingly, a need exists for a relatively inexpensive coupler or hitch for mating smaller lawn and garden implements to towing vehicles, such as self-propelled, ride-on lawn tractors, ATVs and similar towing vehicles, and that is not prone to unintended decoupling of the towed implement from the towing vehicle, even when traversing uneven terrain. The present invention satisfies this need.

### SUMMARY OF THE INVENTION

In accordance with the present invention, there is provided a pintle coupler that is adapted for mating with a hitch ball on a towing vehicle and that comprises a plate member adapted to be attached to an end of a trailer tongue where the plate member has a first aperture formed through its thickness dimension of a size greater than a diameter of the hitch ball with which the hitch coupler is to be used. Pivotally connected to the plate member is a retainer member, the retainer member also comprising a plate that includes a U-shaped inset of a width dimension that is less than the diameter of the hitch ball but greater than the diameter of a stem portion of the hitch ball. The pivotal coupling is such that the retainer member can be rotated from a first position where the U-shaped inset is unaligned with the first aperture in the plate member to a second position where the U-shaped inset is aligned vertically with the first aperture.

The preferred embodiment may further include a second aperture formed through the plate member and an aperture formed through the retainer member such that the second aperture and the aperture formed through the retainer member become aligned when the retainer member is in its second position. When so aligned, a spring-ball pin can be inserted through the aligned apertures to prevent the retainer member from disengaging from the pedestal portion of the hitch ball.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a perspective view from the side of a preferred embodiment of the invention with the pintle coupler uncoupled from a hitch ball;

FIG. 2 is a perspective view from the side showing the pintle coupler joined to the hitch ball, but not yet securely latched;

FIG. 3 is a perspective view from the side with the latch in place and secured; and

FIG. 4 is a bottom plan view of the preferred embodiment.

### DESCRIPTION OF THE PREFERRED EMBODIMENT

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise.

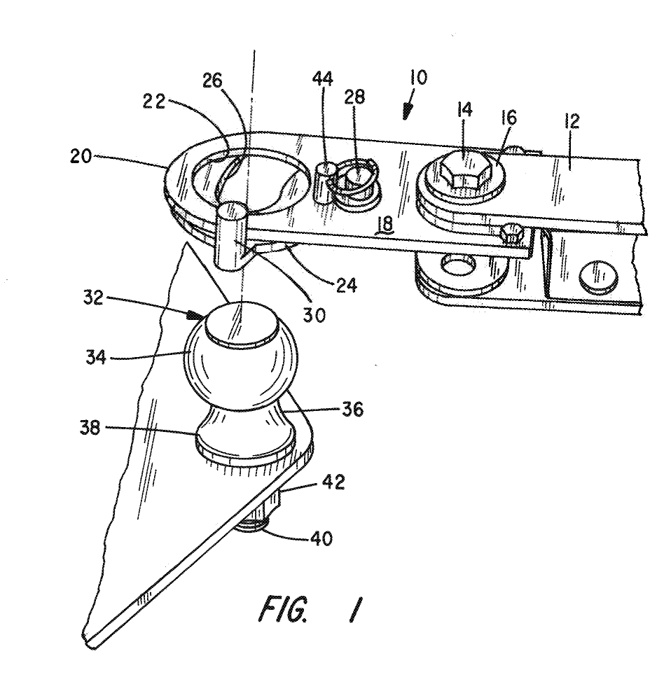

Referring first to FIG. 1, the pintle coupler is indicated generally by numeral 10 and is shown as being fastened to the tongue 12 of a towed implement (not shown) by means of a bolt 14 passing through a flat washer 16 and a nut (not shown) threaded onto the bolt 14 that passes through aligned apertures in the trailer tongue 12 and a plate member 18 of the pintle coupler 10.

The plate member 18 is generally rectangular but with a rounded distal end 20 that is concentric with a first aperture 22. The plate member 18 is preferably cold-rolled steel about ¼ inch in thickness.

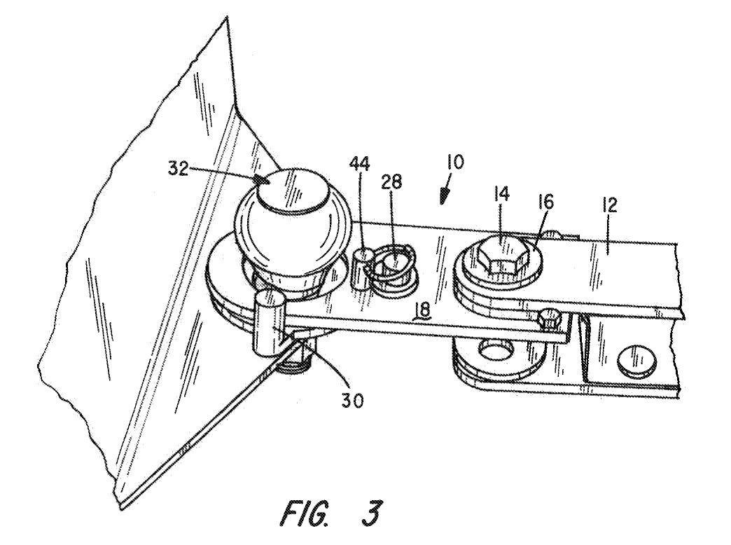

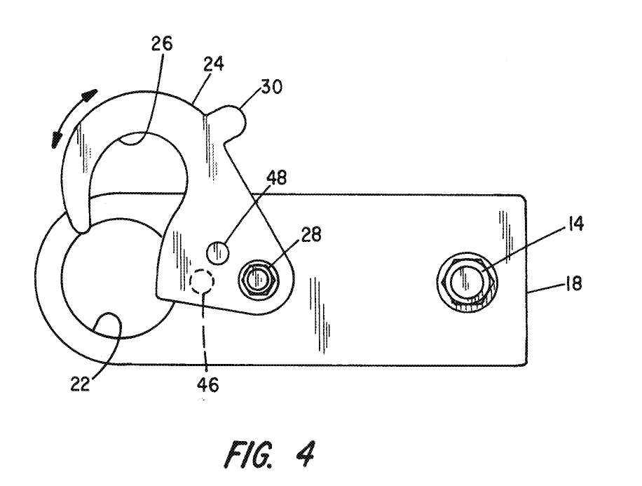

As seen in FIGS. 3 and 4, disposed beneath the plate member 18 and pivotally joined to it is a retainer member 24 also in the form of a steel plate of ¼^{th} inch thickness having a generally U-shaped inset 26 extending inward from one side edge of the retainer member 24.

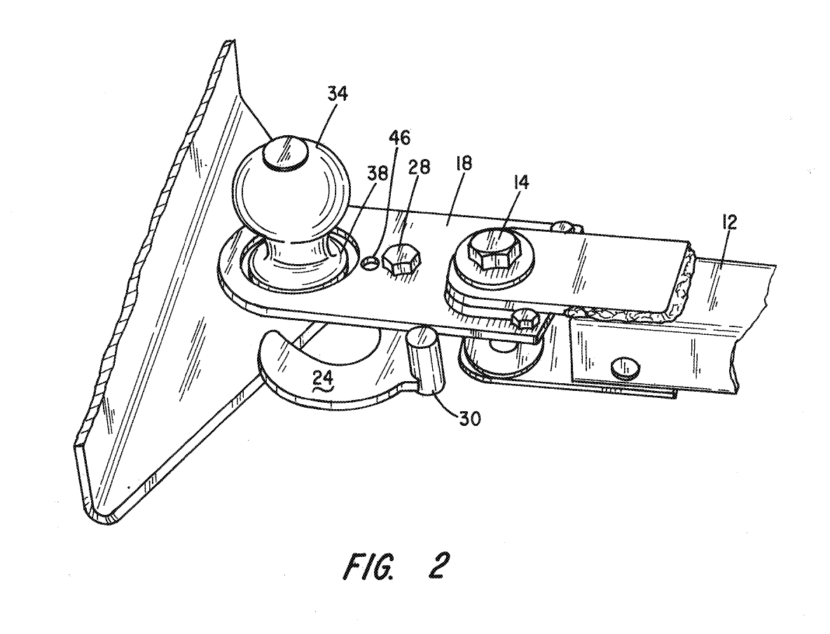

As mentioned, the retainer member 24 is pivotally joined to the plate 18 by means of a shoulder bolt 28 that extends through aligned apertures in the plate member 18 and the retainer member 24. A user, by grasping a handle 30, may rotate the retainer member 24 in a counterclockwise direction about the shoulder bolt 28 from a first position, as shown in FIG. 2, so that it no longer underlays the aperture 22 formed through the thickness dimension of the plate member 18.

In FIG. 1, the pintle coupler of the present invention is juxtaposed next to a conventional hitch ball 32. The hitch ball includes a spherical member 34 atop a pedestal 36 having a flared base 38 resting atop a horizontal flange on the rear of a towing vehicle. Projecting downward from the flared base 38 is a threaded shank 40 on which a nut 42 is threaded for securing the hitch ball 32 to the towing vehicle.

The diameter of the aperture 22 formed in the plate member 18 is slightly larger than the diameter of the sphere 34 such that the pintle coupler plate member 18 may fit over the sphere and rest upon the flared base 38. The width dimension of the inset 26 on the retainer member 24 is only slightly larger than the diameter of the pedestal 36 and less than the diameter of the spherical member 34 such that when it is rotated about the bolt 28 as a pivot in a clockwise direction to a second position, the hitch ball will be captured by the pintle coupler 10, as best seen in the view of FIG. 3.

Also seen in FIGS. 3 and 4 is a locking pin 44 that is made to pass through aligned apertures as at 46 in the plate member 18 and another 48 in the retainer member 24 when the pedestal 36 of the hitch ball is contained within the inset 26 of the retainer member. The locking pin is preferably a conventional spring-ball detent pin known in the art which inhibits unintended removal of the pin from its locking engagement between the plate member 18 and the retainer member 24.

It may be seen, then, that the present invention provides a relatively low cost, yet strong and safe pintle coupler for joining a towing vehicle to a towed implement. This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A pintle coupler adapted for mating with a hitch ball on a towing vehicle comprising:
(a) a plate member adapted to be attached to an end of a trailer tongue, the plate member having a first aperture formed therethrough of a uniform diameter and a size greater than a diameter of said hitch ball; and
(b) a retainer member having a pivotal coupling to the plate member and being in parallel relation to the plate member, the retainer member including a U-shaped inset of a width dimension less than the diameter of said hitch ball and greater than a pedestal portion of the hitch ball, said pivotal coupling being such that the retainer member can be rotated from a first position where the U-shaped inset is unaligned with the first aperture in the plate member to a second position where the U-shaped inset is aligned vertically with the first aperture.

2. The pintle coupler as in claim 1 and further including a second aperture formed through the plate member and an aperture formed through the retainer member such that the second aperture and the aperture formed through the retainer member become aligned when the retainer member is in the second position.

3. The pintle coupler as in claim 2 and further including a locking pin insertable through the second aperture in the plate member and the aperture in the retainer member when the second aperture and the aperture in the retainer member are aligned.

4. The pintle coupler as in claim 3 wherein the retainer member comprises a flat plate with the inset extending from an edge of the flat plate a predetermined distance inward from said edge.

5. The pintle coupler as in claim 4 and further including a handle affixed to the retainer member to facilitate rotation of the retainer member between the first and second positions.

6. The pintle coupler as in claim 3 wherein the locking pin is a spring-ball detent pin.
